(19) United States
(12) Patent Application Publication
(10) Pub. No.: US 2009/0196314 A1
(43) Pub. Date: Aug. 6, 2009

(54) Method and System for a Semiconductor Laser Light Source

(75) Inventor: Walter M. Duncan, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/023,808

(22) Filed: Jan. 31, 2008

(51) Int. Cl. H01S 3/10

(52) U.S. Cl. 372/21; 372/22

(57) ABSTRACT

A laser module includes a Distributed Bragg Reflector semiconductor laser light source that is operable to generate a light beam having a stabilized frequency and spatial mode. A periodically poled, nonlinear optical device is operable to receive the light beam, and frequency-convert the light beam.

### CROSS REFERENCE TO RELATED APPLICATIONS

This application claims the benefit of priority under 35 U.S.C. §119(e) of U.S. Provisional Patent Application Ser. No. 60/877,687 entitled “Frequency Doubled Single Mode Laser for Display Illuminator Applications,” which was filed on Feb. 1, 2007.

### TECHNICAL FIELD

This invention relates in general to optical systems, and more particularly to method and system for a semiconductor laser light source.

### BACKGROUND

Within the optics industry, many systems applications use light sources producing visible radiant power in the milliwatt to hundreds of watts range. Examples of display applications that use visible light sources include front projection, high-definition television, and cinema displays. In some display applications, these light sources must withstand a range of environmental conditions such as high humidity, large temperature excursions, and mechanical shock as well as meet other design constraints including, for example, brightness, efficiency, cost, étendue, heat generation, and/or size. Solid state light sources such as lasers and LEDs are more robust to many environmental factors and often have advantages in brightness, efficiency, cost, etendue, and overall size, as well as producing light with accurate color relative to filament, arc, or gas phase sources.

### SUMMARY

In accordance with the present disclosure, a method and system for a semiconductor laser light source is provided.

In accordance with one embodiment of the present disclosure, a laser module includes a Distributed Bragg Reflector semiconductor laser light source that is operable to generate a light beam having a stabilized frequency and spatial mode. A periodically poled, nonlinear optical device is operable to receive the light beam, and frequency-convert the light beam.

Technical advantages of certain embodiments of the present disclosure include enhanced laser light sources with nonlinear optics tuned to the particular frequency of the light received from a laser emitter. Some such embodiments may include multiple integrated light sources and corresponding NonLinear Optic (NLO) sections all coupled to a common submount and operable to generate light beams in multiple frequency ranges.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and its advantages, reference is now made to the following description, taken in conjunction with the accompanying drawings, in which:

FIG. 1 is a block diagram of a portion of an optical system having plural laser modules as light sources according to one embodiment of the present disclosure;

FIG. 2A is a perspective view of a portion of one of the laser modules of FIG. 1 that includes an emitter optically coupled to a frequency converter according to the teachings of one embodiment of the present disclosure;

FIG. 2B illustrates a cross section of a portion of one of the laser modules of FIG. 1 according to one embodiment;

FIG. 2C illustrates an example propagation of a light beam thru a non-linear optical device that may be used by the optical system of FIG. 1;

FIG. 2D illustrates the non-linear optical device of FIG. 2C having a domain inverted grating with a poling period A according to one embodiment; and

FIG. 3 is a top view of a portion of one of the laser modules of FIG. 1 having an array of emitters optically coupled to an array of multi-dimensional non-linear optic devices according to one embodiment of the present disclosure.

### DETAILED DESCRIPTION

In accordance with the present disclosure, a method and system for a semiconductor laser light source is provided. The method and system may be used in any of a variety of optical applications, including, for example, display applications. Examples of such display applications include home-theater projectors, high-definition televisions (HDTV), and cinema projectors, including those using DLP® technology developed by Texas Instruments Incorporated. Particular examples specified throughout this document are intended for example purposes only, and are not intended to limit the scope of the present disclosure. In particular, this document is not intended to be limited to particular optical application or technology, such as, a display application using DLP® technology.

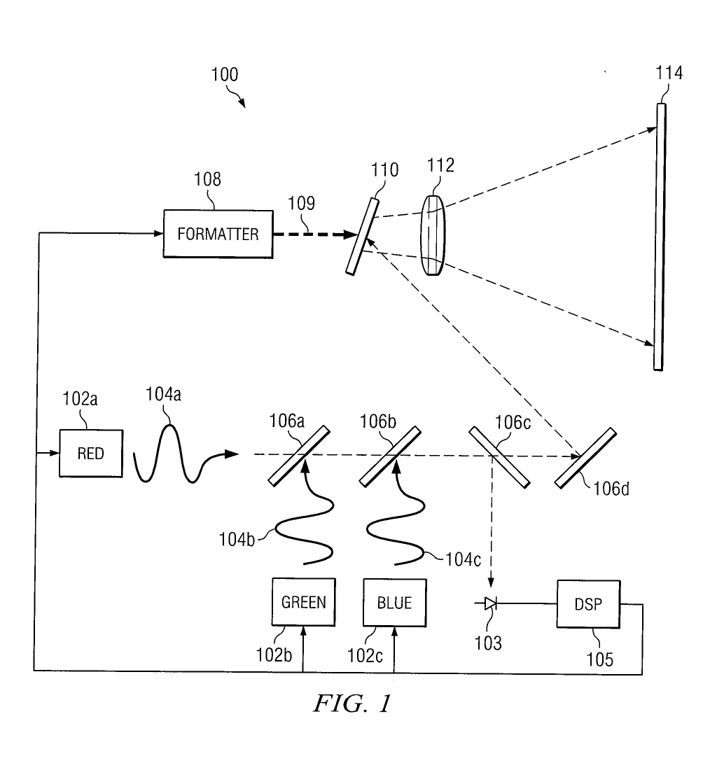

FIG. 1 is a block diagram of a portion of an optical system 100 having plural laser modules 102 as light sources according to one embodiment of the present disclosure. In this example, laser modules 102 generate light beams 104, which are directed by optics 106 to a modulator 110. Optics 106 also directs a portion of light beams 104 to a diode 103 in communication with a processor 105. A formatter receives the output of processor 105 for feedback control of laser modules 102. In addition, formatter 108 controls the operation of modulator 110. Modulator 110 spatially modulates received light beams 104 to form an image that is directed by optics 112 to a display 114. Although this example describes optical system 100 in the context of a display application, any suitable optical system may use light generated by one or more laser modules 102.

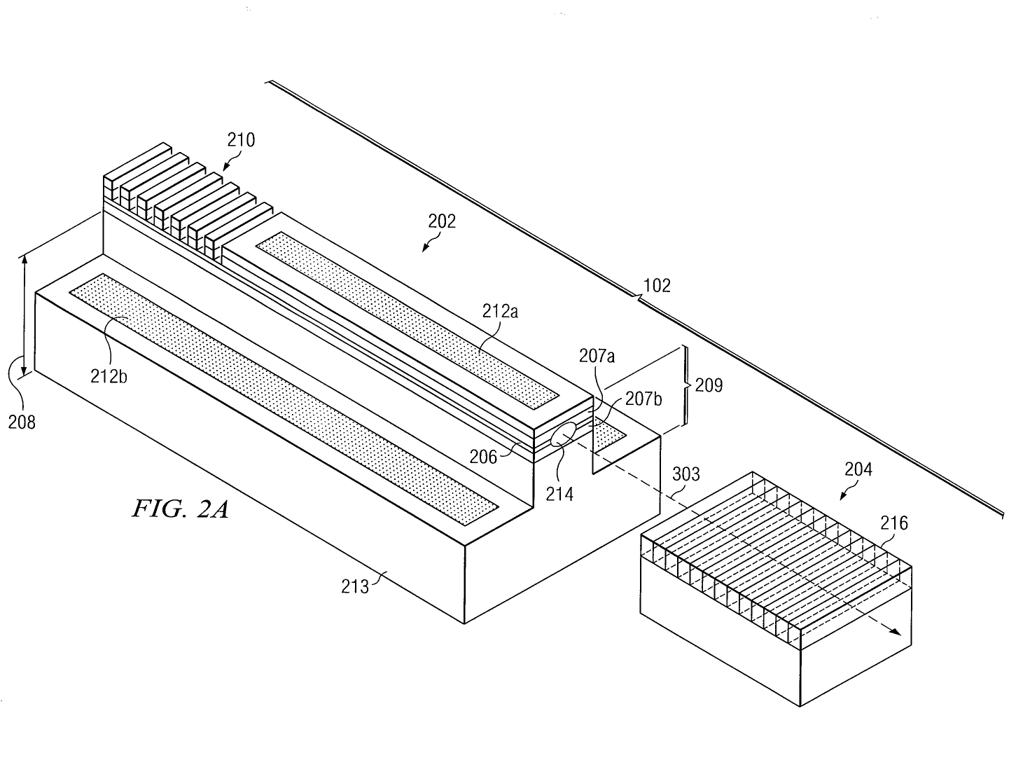

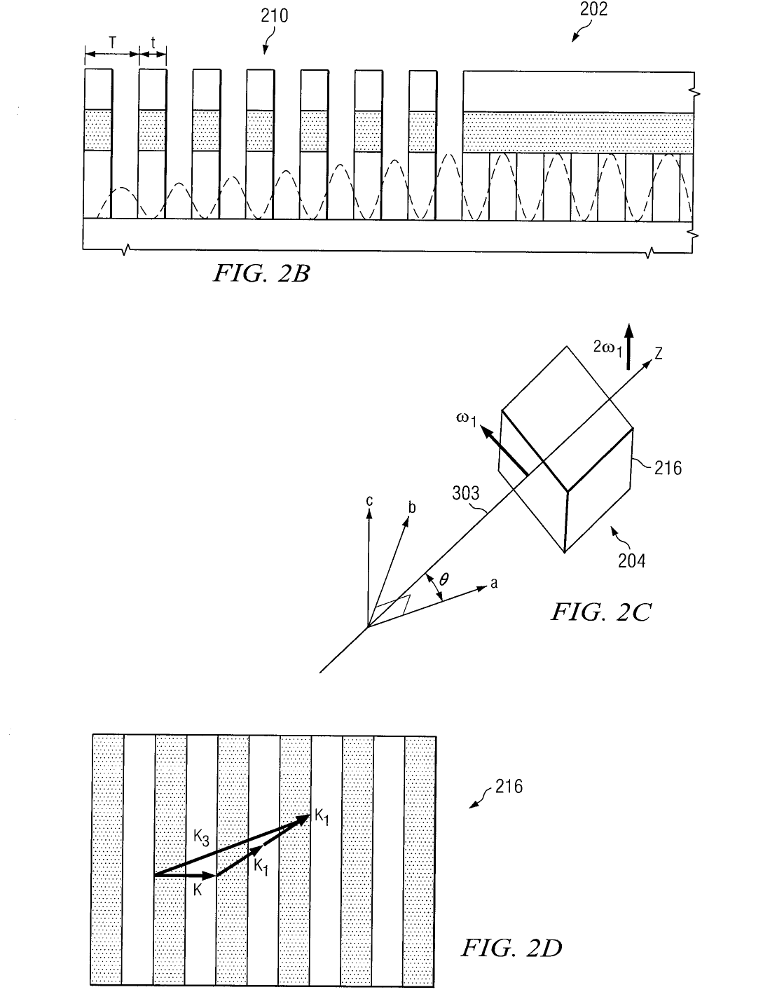

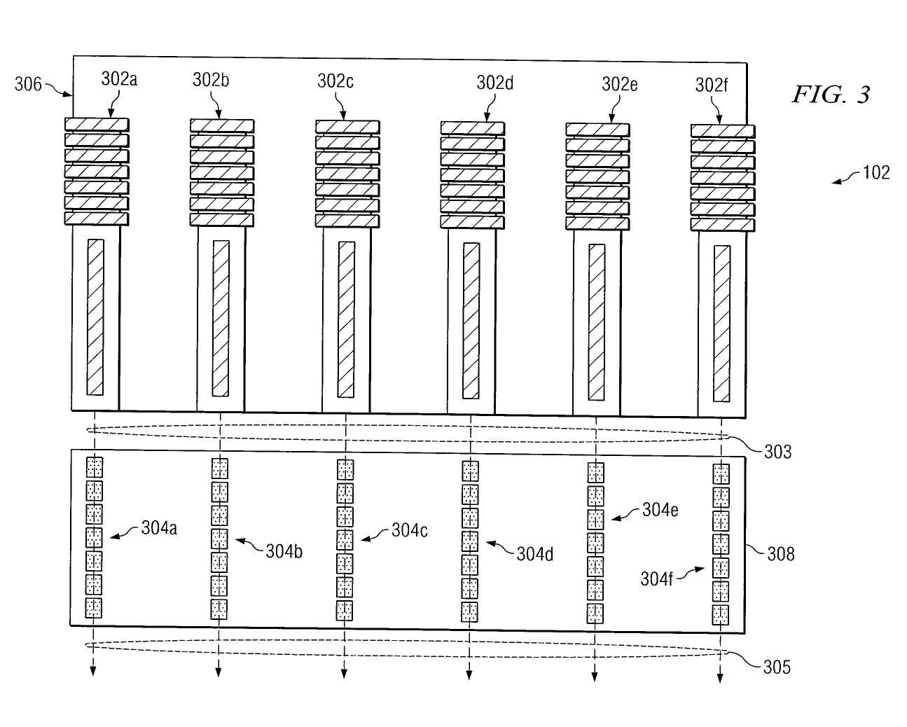

As described further below with reference to FIGS. 2 and 3, laser modules 102a, 102b, and 102c are capable of generating light beams 104a, 104b, and 104c respectively. In this example, light beams 104a, 104b, and 104c each have a particular frequency range within the visible spectrum and sufficient intensity to produce a visible display. Although laser modules 102a, 102b, and 102c are illustrated as producing visible red, green, and blue colored light beams 104a, 104b, and 104c respectively, any suitable frequency ranges and intensities may be used.

Diode 103 generally refers to any device capable of converting optical energy to electrical energy. In this example, the converted electrical energy is typically transmitted in the form of an analog signal or digital signal to a processor 105. One example of processor 105 is a digital signal processor (DSP) 105. Processor 105 generally processes, using real-time computing, the digital conversion of analog electrical signals received from diode 103. The analog-to-digital conversion may be performed, for example, by processor 105 or by some other intermediary device (not explicitly shown). Processor 105 is operable to output a signal indicative of an optical characteristic of light beams 104 generated by laser modules 102. For example, processor 105 may output signals indicative of respective intensity levels for light beams 104a, 104b, and 104c.

Optics 106 generally refers to any optical device(s) capable of directing light beams 104. In the example embodiment, optics 106a, 106b, 106c, and 106d are wavelength specific fold mirrors; however, any suitable optics may be used.

Formatter 108 generally refers to any hardware, software, other logic, or any suitable combination of the preceding that is capable of interfacing with laser modules 102 and/or modulator 110. In the example embodiment, formatter 108 is an application-specific integrated circuit (ASIC) that is further capable of processing input signals. The input signals may include, for example, information corresponding to a photolithographic pattern, an image, or a video stream; however, any suitable input signal may be used. Formatter 108 outputs control signals 109 to light modulator 110 that correspond to the processed input signals. Control signals 109 at least partially control modulator 110 operation. In addition, formatter 108 may output control signals to laser modules 102. For example, formatter 108 may respond to feedback signals received from processor 105 by outputting control signals that adjust the intensity level output of laser modules 102.

Modulator 110 generally refers to any device capable of spatially modulating light. For example, modulator 110 may be a so called back illuminated liquid crystal display, an interferometric modulator, or a liquid crystal on silicon display. In the illustrated embodiment, however, modulator 110 is a digital micromirror device (DMD™) that constitutes a portion of DLP® technology. A DMD™ is a microelectromechanical system (MEMS) device comprising an array of hundreds of thousands of digital micromirrors. In the illustrated embodiment, deflection of each micromirror between “on” and “off” positions is effected by the attractive or repulsive electrostatic forces exerted thereon by electric fields. The electric fields result from the application of appropriate potentials as controlled by formatter 108. The pattern of “on” versus “off” (e.g., light and dark mirrors) forms an image that is projected by optics 112 to display 114. Of course, modulators other than DMDs™ may use the principles of the present disclosure. In addition, some alternative embodiments may include multiple modulators 110. For example, some cinema display applications may include plural modulators 110, each of which may receive a colored light beam generated by a respective laser module 102.

Optics 112 generally refers to any optical element(s) capable of directing the output of modulator 110 to display 114. In the example embodiment, optics 112 includes one or more lens. Display 114 generally refers to any display surface capable of receiving the output of modulator 110 as projected by optics 112. For example, display 114 may be a front or a rear projection screen.

In some applications, light sources are subjected to a range of environmental factors such as high humidity, large temperature excursions, and mechanical shock. In addition, the light sources of various applications have certain design constraints, including, for example, brightness, efficiency, cost, etendue, heat generation, and/or size. Accordingly, the teachings of some embodiments of the present disclosure provide an enhanced semiconductor laser light source 102 that adequately meets the aforementioned design constraints for certain applications. A better understanding of various aspects of some such semiconductor laser light sources may be had by making reference to FIGS. 2A through 3, which illustrate various portions of laser modules 102 in accordance with particular embodiments of the present disclosure.

FIG. 2A is a perspective view of a portion of one embodiment of the laser modules 102 of FIG. 1. Laser module 102 generally includes a Distributed Bragg Reflector (DBR) semiconductor laser diode 202, referred to herein as a DBR emitter 202, which is optically coupled to a periodically poled, nonlinear optical (NLO) frequency-converting bulk or planar device 204. DBR emitter 202 includes a quantum well layer 206 disposed between separate confinement heterostructure (SCH) layers 207a and 207b, all disposed outwardly from a substrate 208. Quantum well layer 206 includes regions where electrons and holes are collected, which are collectively referred to herein as the “quantum well.” A quantum well results in confining electrons and holes as the same location in momentum space which enables efficient “direct” radiant recombination, thereby efficiently producing photons of discrete energy.

A periodic structure 210 generally provides a distributed reflector that provides laser oscillation feedback for emitter 202. As shown in FIG. 2A, periodic structure is integrated into DBR emitter 202, which may facilitate manufacturing and alignment; however, periodic structure 210 may alternatively be a non-integrated structure that is optically coupled to DBR emitter 202, for example, near a gain region of the quantum well. Periodic structure 210 may act as a distributed reflector for a predetermined wavelength range of laser action. In some embodiments, periodic structure 210 may include a concatenation of multiple Bragg gratings within the internal optical gain section of the laser. In the case where the Bragg grating is within the gain section, the laser is referred as a Distributed-FeedBack (DFB) laser. In this example, periodic structure 210 enables single-frequency operation and a corresponding longitudinal mode for the DBR emitter 202 in a manner that is spatially and temporally matched to periodically poled, NLO device 204, as explained further below.

Laser modules 102 having single-frequency, single longitudinal modes of operation typically have significantly enhanced frequency-doubling efficiency relative to multi-frequency sources. Some single frequency structures that use quantum wells to confine charge, however, are inefficient photon waveguides because the quantum well is too thin to efficiently confine the emitted photons. In other words, the quantum wells may be considerably thinner than the wavelength of generated light. Accordingly, Second Confinement Heterostructure (SCH) layers 207a and 207b are high to low index structures on both sides of the quantum well layer 206 that may confine the generated photons to the quantum well plane. SCH layers 207a and 207b can use any of a number of index of refraction profiles, such as, for example, a step function grading or a parabolic grading. In this example, the product of the combined thickness of layers 206, 207a and 207b and the combined effective index of refraction is approximately equivalent to one wavelength of the light emitted from laser module 102, thereby efficiently confining emitted photons to a single mode.

DBR emitter 202 also includes a set of electrodes 212 that are capable of injecting charge into a structural or index of refraction ridge or region 209 containing the quantum well layer 206 and may contain all or parts of the SCH 207a and 207b. A region of the structure 209 can be defined by etching, ion implantation, diffusion, or other chemical or thermal process that further confine the emitted photons in a dimension transverse both to the quantum well and the propagation direction of the photon. That is, SCH layers 207a and 207b and transverse relief structure 209 collectively provide a two-dimensional waveguide for the photons produced in the quantum well.

A quantum facet 214 reflects and transmits portions of the received light. Quantum facet 214 is typically passivated to avoid optical damage. The passivation material may include, for example, Al₂O₃, ZnSe and Si. Various embodiments may diffuse a lifetime killing impurity into quantum facet 214 to prevent optical recombination from taking place in proximity to the quantum facet 214. Proper material selection for quantum facet 214 may further mitigate optical damage.

Designing DBR emitter 202 with good recombination lifetimes and minimal parasitic recombination paths, series resistance, and strain in layers 206, 207a, and 207b may stimulate highly efficient photon emission from quantum facets 214. However, to be generally useful for visual display applications, if the directly generated light is in the Near Infrared (NIR) it can be converted to the visible range via one of a number of nonlinear optical processes.

In this example, periodically poled, NonLinear Optic (NLO) device 204 is generally configured to frequency-convert light beams 303 received from respective DBR emitters 202. For example, the periodically-poled NLO device 204 may achieve phase or quasi-phased matching of fundamental frequency photons and corresponding harmonic photons through artificially structuring the material. In this manner, the NLO device 204 may convert NIR light beams 303 to higher frequencies within the green or blue color spectrum. As shown in FIG. 2A, the periodically poled NLO device 204 can be configured to spatially confine the fundamental frequency light beams in either one or two dimensions.

Such periodically poled NLOs 204 may achieve cost savings over designs using bulk phase matching, e.g. birefringent phase matching. Brirefringent phase matching typically requires using a precision cut crystal that is highly sensitive to temperature fluctuation. Periodically-poled NLO 204 may include any of a variety of crystalline compounds 216, such as, for example, Potassium Titanyl Phosphate (KTP), Potassium Lithium Niobate (PLN), Lithium Niobate (LN), Lithium Tantalate (LT), Lithium Borate (LBO), beta-Barium Borate (BBO), GaN and other III-V compounds.

In this example, periodically poled NLO device 204 is tuned to the particular frequency of the light received from DBR emitter 202 according to a mathematical relationship with periodic portion 210. In this manner, NLO device 204 may efficiently convert the frequency of light from DBR emitter 202. The mathematical relationship is described further below with reference to FIGS. 2B through 2D.

FIG. 2B illustrates a cross section of a portion of the DBR emitter 202 of FIG. 2A according to one embodiment. The illustrated portion of DBR emitter 202 includes periodic structure 210, which may operate as a Bragg Reflector outside the gain or active region of laser module 102. In this case, a Bragg Reflector is a light reflecting structure based on a periodic structure that may attenuate wave amplitude in manner similar to that illustrated in FIG. 2B. The Bragg wavelength, λ_{B}, of periodic structure 210 is given by:

λ_{B}=2n_{eff}T Equation 1

Where T is the period of the structure 210, that is periodic in index of refraction, and n_{eff} is the effective dielectric constant of the Bragg structure. The effective dielectric constant of periodic structure 210 is

$${n}_{eff} = ( \frac{T - t}{T} ) {n}_{air} + ( \frac{t}{T} ) {n}_{mat} \qquad Equation 2$$

FIG. 2C illustrates an example of a light beam 250 propagating thru a periodically poled NLO 204 according to one embodiment. The atomic packing structure of the NLO crystal 216 determines the crystallographic and optical properties of the material. An orthogonal three dimensional coordinate system with axis denoted as a, b and c is typically used to describe these crystallographic and optical directions of the crystal. FIG. 2C designates a representative coordinate system for frequency doubling in a bulk nonlinear optic crystal 216.

The index of refraction for a given propagation direction in the crystal 216 can be calculated using Equation 3:

$$\frac{1}{{n}_{θ}^{2}} = \frac{{cos}^{2} θ}{{n}_{b}^{2}} + \frac{{sin}^{2} θ}{{n}_{a}^{2}} \qquad Equation 3$$

where nₐ and n_{b} are the indices of refraction for the a and b directions and θ is the angle formed between the a and b directions.

For efficient frequency doubling a fundamental wave, the fundamental and doubled wave may propagate thru a nonlinear crystal 216 at the same rate. The propagating waves for the fundamental and second harmonic can be described in terms of the magnitude, k, of the wavevector also known as the propagation constant. The difference between the propagation constants for the fundamental and second harmonic, Δk for the optical waves propagating in the Z direction in the figure can be written as:

$$Δ k = \frac{4 π}{{λ}_{1}} [ nc ( 2 {ω}_{1} ) - {n}_{θ} ( {ω}_{1} ) ] \qquad Equation 4$$

where λ₁ is the wavelength of the fundamental wave, n_{c}(2ω₁) is the index of refraction in the c direction at the second harmonic and n_{θ}(ω₁) is the index of refraction of the fundamental wave in the propagation direction. When Δk is approximately zero, crystal 216 of NLO device 204 may efficiently frequency double received light beam 303.

FIG. 2D illustrates the periodically poled Non-Linear Optic (NLO) 204 of FIG. 2C having a domain inverted grating with a poling period Λ according to one embodiment. In the illustrated example, periodically poled NLO 204 is poled such that there is a reversal of sign of the non-linear susceptibility over a coherence length of crystal 216. This is referred to as a domain inverted grating. In this case the poled regions have a coherence length, l_{c}, that is given by:

l_{c}=π/Δk Equation 5

Again for a periodically poled nonlinear material, the spatial period of the poling, Λ is given by Equation 6:

$$Λ = \frac{2 π}{Δ k} \qquad Equation 6$$

The phase matching condition for the periodically poled case is given by

Δk=k₃−2k₁−K Equation 7

Where K is the magnitude of the wavevector for the poled material and is given by:

$$K + \frac{2 π m}{Λ} \qquad Equation 8$$

Combining Equation 4 for Δk with direction with Equation 6 for Δk with poling we calculate the spatial poling period for a wavelength and a set of indices of refraction.

$$Λ = \frac{λ}{2 [ {n}_{c} ( 2 {ω}_{1} ) - {n}_{θ} ( {ω}_{1} ) ]} \qquad Equation 9$$

Thus, in some embodiments, periodically poled NLO 204 may be tuned to the particular frequency of the light received from DBR emitter 202 according to the mathematical relationships described with reference to equations 1 through 9. In this manner, NLO device 204 may efficiently frequency double the radiant power emitted from laser 102. In some alternative embodiments, NLO device 204 may be a multi-dimensional waveguide, as illustrated further with reference to FIG. 3.

FIG. 3 is a top view of a portion of one of the laser modules 102 of FIG. 1 having an array of emitters 302 optically coupled to an array of periodically poled NLOs 304 according to one embodiment of the present disclosure. In this example, DBR emitters 302a, 302b, 302c, 302d, 302e, and 302f are coupled to a common substrate 306 and are each substantially similar in structure and function to DBR emitter 202 of FIG. 2.

In this example, periodically poled NLOs 304 are each substantially similar in structure and function to periodically poled NLOs 204, with the exception that periodically poled NLOs 304 may spatially confine received light beams in one or two dimensions. Forming waveguides with the general structure illustrated in FIG. 3 may be effected, for example, by etching away appropriate regions of a nonlinear crystalline compound. Such etched regions may include material transverse to the poling direction and the propagation direction of the NLO device 304.

Alternative embodiments may not include multi-dimensional waveguides 304. For example, some alternative embodiments may use a non-etched, periodically poled, continuous crystalline compound that is not singulated in a manner similar to poled regions 304a, 304b, 304c, 304d, 304e, and 304f. In other alternative embodiments, poled regions 304a, 304b, 304c, 304d, 304e, and 304f may have varying structural designs with respect to each other. Some embodiments may not include device 304 at all. For example, some applications may use Near Infrared (NIR) light beams generated by emitters 302 without the use of NLO devices.

As illustrated in FIG. 3, poled regions 304a, 304b, 304c, 304d, 304e, and 304f are coupled to a common substrate 308. Although FIG. 3 illustrates substrates 306 and 308 as separated, substrates 306 and 308 are typically physically coupled together to facilitate alignment. In some embodiments, substrates 306 and 308 may be a single common substrate. Some embodiments may include lens array or individual lenses (not explicitly shown) disposed between the array of emitters 302 and NLO device 304.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A laser module comprising:
a Distributed Bragg Reflector, semiconductor laser light source operable to generate a light beam, the light source comprising:
a quantum well layer disposed between separate confinement heterostructure layers operable to confine the light beam to a plane;
a ridge transverse to the quantum well layer, the ridge operable to confine the light beam in a second dimension traverse to a propagation direction of the light beam; and
a first periodic structure configured to act as a Bragg reflector and operable to stabilize a single oscillation wavelength of the light beam;
a periodically poled, nonlinear optical device operable to receive the light beam, and frequency-convert the light beam, the nonlinear optical device comprising a second periodic structure operable to control an emission wavelength of the frequency-converted light beam; and
wherein the first periodic structure has the following mathematical relationship:
λ_{B}=2n_{eff}T
and the second periodic structure has the following mathematical relationship:
$$Λ = \frac{λ}{2 [ {n}_{c} ( 2 {ω}_{1} ) - {n}_{θ} ( {ω}_{1} ) ]}$$
where n_{c}(2ω₁) is an index of refraction of the nonlinear optical device, λ is a fundamental wavelength of a fundamental wave of the light beam, n_{θ}(ω₁) is an index of refraction of the fundamental wave in the propagation direction of the light beam, and Λ is a poling period of the nonlinear optical device.

2. The laser module of claim 1, wherein at least a portion of the first periodic structure is integrated into at least a portion of the quantum well layer.

3. The laser module of claim 1, wherein at least a portion of the first periodic structure is integrated into at least a portion of the separate confinement heterostructure layers.

4. The laser module of claim 1, wherein the periodically poled, nonlinear optical device is operable to confine the received light beam in two dimensions.

5. The laser module of claim 1, wherein the periodically poled, nonlinear optical device is formed from a crystalline compound.

6. The laser module of claim 5, wherein the crystalline compound is formed from material selected from the group consisting of:
potassium titanyl phosphate;
potassium lithium niobate;
lithium niobate;
lithium tantalate;
lithium borate;
beta-barium borate;
GaN; and
other III-V compounds.

7. The laser module of claim 1, wherein the light source and the periodically poled, nonlinear optical device are physically coupled to each other.

8. The laser module of claim 1, further comprising:
a first array comprising a plurality of the Distributed Bragg Reflector semiconductor laser light sources;
a second array comprising a plurality of the periodically poled, nonlinear optical devices;
wherein each laser light source of the first array is optically coupled to a respective device of the second array.

9. A laser module comprising:
a Distributed Bragg Reflector semiconductor laser light source operable to generate a light beam having a stabilized frequency and spatial mode; and
a periodically poled, nonlinear optical device operable to receive the light beam, and frequency-convert the light beam.

10. The laser module of claim 8, wherein the laser light source and the nonlinear optical device comprise first and second periodic structures, respectively, the first and second periodic structures each operable to control an emission wavelength of the light beam; and
wherein the first periodic structure has the following mathematical relationship:
λ_{B}=2n_{eff}T
and the second periodic structure has the following mathematical relationship:
$$Λ = \frac{λ}{2 [ {n}_{c} ( 2 {ω}_{1} ) - {n}_{θ} ( {ω}_{1} ) ]}$$
where n_{c}(2ω₁) is an index of refraction of the nonlinear optical device, λ is a fundamental wavelength of a fundamental wave of the light beam, n_{θ}(ω₁) is an index of refraction of the fundamental wave in the propagation direction of the light beam, and Λ is a poling period of the nonlinear optical device.

11. The laser module of claim 8, wherein the Distributed Bragg Reflector semiconductor laser light source and the periodically poled, nonlinear optical device are physically coupled to each other.

12. The laser module of claim 8, further comprising:
a first array comprising a plurality of the Distributed Bragg Reflector semiconductor laser light sources;
a second array comprising a plurality of the periodically poled, nonlinear optical devices;
wherein each laser light source of the first array is optically coupled to a respective device of the second array.

13. The laser module of claim 8, wherein the periodically poled, nonlinear optical device is formed from a crystalline compound.

14. The laser module of claim 5, wherein the crystalline compound is formed from material selected from the group consisting of:
potassium titanyl phosphate;
potassium lithium niobate;
lithium niobate;
lithium tantalate;
lithium borate;
beta-barium borate;
GaN; and
other III-V compounds.

15. A method for generating visible light comprising:
optically coupling a stabilized, single-frequency laser beam emitted by a distributed-feedback semiconductor laser diode to a periodically poled, nonlinear optical device;
frequency converting, by the periodically poled, nonlinear optical device, the light beam emitted by the laser diode; and
confining the light beam, by the periodically poled, nonlinear optical device, in at least one dimension.

16. The method of claim 15, wherein the distributed-feedback semiconductor laser diode and the periodically poled, nonlinear optical device comprise first and second periodic structures, respectively, the first and second periodic structures each operable to control an emission wavelength of the light beam; and
wherein the first periodic structure has the following mathematical relationship:
λ_{B}=2n_{eff}T
and the second periodic structure has the following mathematical relationship:
$$Λ = \frac{λ}{2 [ {n}_{c} ( 2 {ω}_{1} ) - {n}_{θ} ( {ω}_{1} ) ]}$$
where n_{c}(2ω₁) is an index of refraction of the nonlinear optical device, λ as a fundamental wavelength of a fundamental wave of the light beam, n_{θ}(ω₁) is an index of refraction of the fundamental wave in the propagation direction of the light beam, and Λ is a poling period of the nonlinear optical device.

17. The method of claim 15, further comprising physically coupling together the distributed-feedback semiconductor laser diode to the periodically poled, nonlinear optical device.

18. A display system comprising:
a laser module comprising:
a distributed-feedback semiconductor laser diode operable to generate a light beam having a stabilized wavelength;
a periodically poled, nonlinear optical device operable to receive the light beam, and frequency-convert the light beam;
a light modulator optically coupled to the laser module and operable to spatially modulate the frequency-converted light beam;
one or more optical elements operable to direct the spatially modulated light beam;
a display surface operable to receive at least a portion of the light beam directed by the one or more optical elements; and
wherein the distributed-feedback semiconductor laser diode and the periodically poled, nonlinear optical device comprise first and second periodic structures, respectively, the first and second periodic structures each operable to control an emission wavelength of the light beam, the first periodic structure having the following mathematical relationship:
λ_{B}=2n_{eff}T
and the second periodic structure having the following mathematical relationship:
$$Λ = \frac{λ}{2 [ {n}_{c} ( 2 {ω}_{1} ) - {n}_{θ} ( {ω}_{1} ) ]}$$
where n_{c}(2ω₁) is an index of refraction of the nonlinear optical device, λ is a fundamental wavelength of a fundamental wave of the light beam, n_{θ}(ω₁) is an index of refraction of the fundamental wave in a propagation direction of the light beam, and Λ is a poling period of the nonlinear optical device.

19. The display system of claim 18, wherein the distributed-feedback laser diode and the periodically poled, nonlinear optical device are physically coupled together.

20. The display system of claim 18, wherein the frequency-converted light beam has a wavelength within the visible spectrum.
